(19) United States
(12) Patent Application Publication
(10) Pub. No.: US 2015/0110933 A1
(43) Pub. Date: Apr. 23, 2015

(54) APPARATUS AND METHOD FOR OHMIC-HEATING A PARTICULATE LIQUID

(71) Applicant: FRUIT TECH NATURAL S.A., ESPINARDO (Murcia) (ES)

(72) Inventor: Yoram Zack, Espinardo (Murcia) (ES)

(73) Assignee: FRUIT TECH NATURAL S.A., ESPINARDO (Murcia) (ES)

(21) Appl. No.: 14/403,140

(22) PCT Filed: May 22, 2013
(86) PCT No.: PCT/EP2013/060550

§ 371 Date: Nov. 21, 2014

(30) Foreign Application Priority Data
May 23, 2012 (EP) 12382192

(51) Int. Cl. A23L 3/005; H05B 3/00; A23L 2/02; F24H 1/10

(52) U.S. Cl. CPC A23L 3/005; F24H 1/103; H05B 3/0009; A23L 2/02; A23V 2002/00
USPC 426/237; 392/314

(57) ABSTRACT

Apparatus for the ohmic-heating of a particulate liquid, including degassing structure for degassing the liquid, which is turn includes a vacuum tank and at least one sprayer, in order to carry out a method that may include degassing the liquid by spraying it onto a vertical or sloping internal wall of a vacuum tank, in such a way that a vertical cylindrical inner region of the vacuum tank that is away from said wall and reaches the top region of the vacuum tank is substantially free of liquid. The apparatus also includes a conduit for passing the degassed liquid through an ohmic-heating unit, a pump located between the vacuum tank and the ohmic-heating unit, a safety valve arranged in parallel with the pump and a back-pressure valve located after the ohmic-heating unit.

The developments hereof are related to a method for ohmic-heating a particulate liquid and to an apparatus for the ohmic-heating of a particulate liquid, the apparatus comprising degassing structure for degassing the liquid.

In the context of the present disclosure, a ‘liquid’ is meant to be an electrically conductive liquid and to encompass particulate liquids, i.e., liquids having solid particles mixed therein, e.g. pulpy juices.

### BACKGROUND

It is known to heat a conductive liquid by circulating an electric current therein through a pair of electrodes, the conductive liquid being the resistive element which is electrically heated. This is called ohmic or resistive heating and has been applied to the sterilisation of foodstuffs such as fruit juices. With this technology heating is more uniform and can be completed in a very short time, but problems may arise.

For instance, if air bubbles are present in the liquid arcing may occur. Arcing is the occurrence of an electric arc, i.e., an electrical breakdown of a gas resulting from a current flowing through normally non-conductive media, such as air. Arcing can burn particles (like pulp) that may be present in the liquid (e.g. juice), resulting in black spots that render the pasteurized juice unsuitable.

Arcing can also occur when there are regions not fully filled with liquid, in which case an electric arc might jump through said empty regions (actually containing air) and calcine particles present in the liquid.

### SUMMARY

An aspect hereof is to provide an ohmic heating system that avoids arcing and the consequent fouling of a particulate liquid when it is ohmic-heated.

According to an aspect hereof, the method for ohmic-heating a particulate liquid includes the step of degassing the liquid by spraying it onto a vertical or sloping internal wall of a vacuum tank, in such a way that a vertical cylindrical inner region of the vacuum tank that is away from said wall and reaches the top region of the vacuum tank is substantially free of liquid. Since there is a vacuum in the tank, gas bubbles escape from the liquid film that is flowing down said internal wall of the vacuum tank and go up across said vertical cylindrical inner region unhindered, to be evacuated from the top region of the vacuum tank.

Gas bubbles in a liquid experience an upward force (principle of Archimedes) and a downward force (due to the surface tension of the liquid). The bigger the bubble the bigger is the upward force and the smaller is the downward force. In the vacuum tank, the thinner the film that flows down the wall of the tank the larger is the area of the wall covered by the film and the longer is the time it takes for the film to flow completely down said wall, so that even small air bubbles are subjected to less downward force and besides they have more time to escape the film and ascend through the innermost region of the tank.

So, in some embodiments, the liquid is sprayed onto at least a portion of the vertical or sloping internal walls of the vacuum tank, and the larger that portion is the more gas bubbles can escape from the liquid film.

The liquid is ohmic-heated after having been degassed (e.g. de-aerated), whereby arcing is prevented.

In some embodiments, the conduits within which the flow of liquid is ohmic-heated are kept substantially full of liquid, so that no empty or gaseous spaces are present in said conduits. A way to achieve this is by keeping the pressure in said conduits between a minimum level and a maximum level, that is, above a set level (the maximum level is a security level). Another way to achieve it is by preventing the pressure drop otherwise produced in the conduits when an end-valve is opened to discharge the ohmic-heated liquid, for example to fill containers with pasteurized juice. Another way to achieve it is by keeping the flow-rate of the liquid being ohmic-heated at substantially a set level.

According to another aspect hereof, the apparatus for the ohmic-heating of a particulate liquid has degassing structure including a vacuum tank and at least one sprayer arranged for spraying the liquid onto a vertical or sloping internal wall of the vacuum tank, in order to carry out the preceding method, the apparatus also having at least one duct or conduit for passing the degassed liquid through an ohmic-heating unit, although there may be several sprayers and the liquid may be sprayed onto at least a portion of the vertical or sloping internal walls of the vacuum tank.

Anyway, a desirable aspect is that the surface of the film flowing down the internal walls of the vacuum tank is large, so that most of the gas bubbles in the liquid can leave the film and go up the central region of the tank (the mentioned vertical cylindrical inner region).

Some embodiments of the apparatus include one or more stabilization structures to keep said conduits substantially full of liquid. Said stabilization structures may include one or more valves to keep the pressure in the conduits between a minimum level and a maximum level, for example a back-pressure valve located after the ohmic-heating unit, and, for security reasons, a safety valve as described below. Or the stabilization structures may include (or also include) one or more pumps, for instance a pump arranged between the vacuum tank and the ohmic-heating unit to pump liquid through the latter.

In some embodiments one or more pumps may include two or more pumping stages arranged in series, for example four pumping stages arranged in series, maybe being part of a positive pump. This arrangement reduces the flow-rate variation caused by a pressure disturbance.

The stabilization structures may also include a safety valve arranged in parallel with the pump, in order to prevent the pressure from exceeding the maximum level.

### BRIEF DESCRIPTION OF THE DRAWINGS

Some embodiments will be described in the following, only by way of non-limiting example, with reference to the appended drawing, in which:

FIG. 1A is a schematic view of an apparatus according to the present disclosure and claims; and

FIG. 1B is a schematic sectional top view of a detail of the vacuum tank.

### DETAILED DESCRIPTION

An apparatus for the ohmic-heating of a pulpy fruit juice (i.e. a juice having particles of fruit pulp) may include a vacuum tank 10 for degassing (de-aerating) said juice prior to ohmic-heating it. A vacuum pump 12 can provide a vacuum inside the vacuum tank 10.

The juice enters the vacuum tank through a sprayer 11 provided with one or more nozzles 13 for spraying the juice into the tank. The vacuum tank 10 has one or more vertical internal walls (it may have a substantially cylindrical shape with a vertical surface) and the nozzles 13 are arranged for spraying the juice onto the vertical walls, so that a downwards flowing film of juice can be established on said walls. The bottom region of the vacuum tank 10 may be shaped as an inverted cone and have an outlet for the deaerated juice at the tip of the cone.

In the vacuum situation prevailing in the vacuum tank 10, the air bubbles present within the juice tend to escape from the liquid. In the case of the film flowing down the vertical or sloping walls (vertical for the cylindrical portion, sloping for the conical portion), a large surface of liquid is exposed to the vacuum environment and consequently a lot of air can leave the liquid film and reach the central region of the tank, away from the walls. The thinner the film the longer it takes for the film to flow down the whole length of the walls and the more air bubbles can escape the liquid.

Since practically no liquid is pouring through said central region, the gaseous air can be extracted, through an exit at the top region of the tank 10, by the vacuum pump 12, unimpeded.

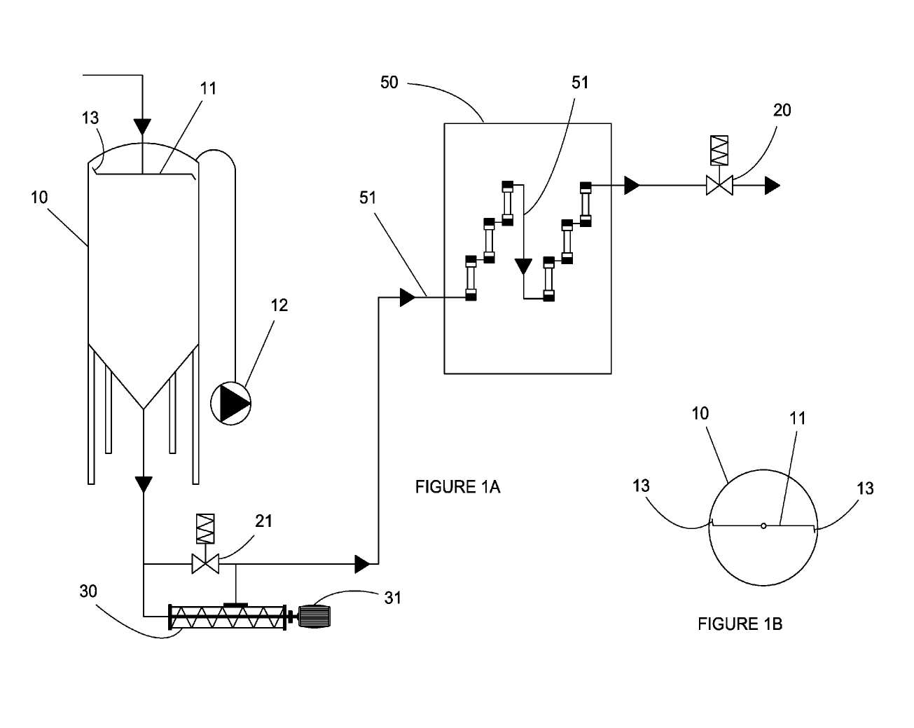

The nozzles 13 of the sprayer 11 can be arranged in any way that manages to cover most of the internal walls of the tank 10 with the film of juice. For example, the sprayer 11 may include two diametrically opposed nozzles 13 tangentially directed in opposite senses towards the cylindrical inner wall of the tank (see FIG. 1B), in order to cover most of the wall with the thin film, half wall each.

Downstream from the vacuum tank 10, a pump 30 (e.g. a positive pump) can pump the degassed juice into an ohmic-heating unit 50. The pump 30 is specially designed to provide a substantially stable flow of juice because it is important that the amount of time the juice is ohmic-heated remains fairly constant, in order to raise the temperature of the liquid by a determined amount. A constant flow-rate can comply with this requirement. The pump 30 thus produces a substantially constant flow-rate under small but significant pressure fluctuations.

The pump 30 may include an electric motor 31 and four pumping stages, for example four rotors arranged in series or a rotor four times longer and having four times as many blades, vanes or whatever the energy-transmitting element is, as a single stage pump. This arrangement can keep the flow relatively stable under such a pressure fluctuation. In effect, when, for some reason, there is a pressure disturbance after a rotary positive pump, there is a certain back-flow in the gap between the rotor and the stator of the pump and the flow-rate in the system may be lowered. But with, for example, four pumping stages, the effect of an eventual pressure disturbance is a quarter than with a single stage, and the flow-rate variation is also a quarter. And the same, of course, can be said of four pumps arranged in series.

Another advantage of such a multi-stage pumping arrangement is that it helps to keep the duct or conduits 51 for the juice in the ohmic-heating unit 50 completely filled with juice, because otherwise a reduction in the flow-rate might leave some spaces in said conduits devoid of liquid, which, as already mentioned, can cause arcing.

Downstream from the ohmic-heating unit 50, but prior to the final outlet for delivering the sterilized or pasteurized juice, there is a back-pressure or constant-pressure valve 20, that is, a valve for sustaining the upstream pressure at a preset level. This prevents pressure falls that might make the juice to boil in the ohmic-heating unit, which would utterly impair the heating of the juice. It also prevents the generation of spaces that are empty of liquid, thus contributing, together with the pump 30, to avoid arcing. Such a pressure fall may occur when filling barrels with pasteurized juice at said final outlet.

As shown in the figure, a safety valve 21 can be arranged upstream from the ohmic-heating unit 50, in parallel with the pump 30, in order to prevent the pressure in the apparatus from getting too high. The operation is as follows.

As an illustrative example, let's suppose that the chosen operational pressure is 10 bars. Then the constant-pressure valve 20 can be set to open when the pressure upstream reaches 10 bars and to close when the pressure downstream falls below 10 bars. Let's suppose that the maximum admissible pressure is 15 bars. Then the safety valve 21 can be set to open when the pressure downstream reaches, say, 14 bars, so that a closed-circuit flow into and out of the pump 30 and through the safety valve 21 can be established, thus preventing the pressure downstream from exceeding 15 bars.

Although only particular embodiments of the invention have been shown and described in the present specification, the skilled person will be able to introduce modifications and substitute any technical features thereof with others that are technically equivalent, depending on the particular requirements of each case, without departing from the scope of protection defined by the appended claims.

1. A method for ohmic-heating a particulate liquid, comprising:
degassing the liquid by spraying it onto a vertical or sloping internal wall of a vacuum tank, in such a way that a vertical cylindrical inner region of the vacuum tank that is away from said wall and reaches the top region of the vacuum tank is substantially free of liquid, and
ohmic-heating a flow of the degassed liquid.

2. The method according to claim 1, wherein the degassing includes spraying the liquid onto at least a portion of the vertical or sloping internal walls of the vacuum tank.

3. The method according to claim 1, comprising spraying the liquid onto a vertical internal wall of the vacuum tank.

4. The method according to claim 1, comprising keeping the conduits within which the flow of liquid is ohmic-heated substantially full of liquid.

5. The method according to claim 4, comprising keeping the pressure in said conduits between a minimum level and a maximum level.

6. The method according to claim 5, comprising preventing the pressure drop otherwise produced in the conduits when an end-valve is opened to discharge the ohmic-heated liquid.

7. The method according to claim 4, comprising keeping the flow-rate of the liquid being ohmic-heated at substantially a set level.

8. An apparatus for the ohmic-heating of a particulate liquid, comprising degassing structure for degassing the liquid, wherein the degassing structure comprises a vacuum tank and at least one sprayer arranged for spraying the liquid onto a vertical or sloping internal wall of the vacuum tank, in order to carry out the method of claim 1, and wherein the apparatus comprises at least one conduit for passing the degassed liquid through an ohmic-heating unit.

9. The apparatus according to claim 8, comprising stabilization structure to keep said conduit substantially full of liquid.

10. The apparatus according to claim 9, wherein the stabilization structure comprises a valve to keep the pressure in said conduit between a minimum level and a maximum level.

11. The apparatus according to claim 10, wherein said valve comprises a back-pressure valve located after the ohmic-heating unit.

12. The apparatus according to claim 9, wherein the stabilization structure comprises a pump located between the vacuum tank and the ohmic-heating unit.

13. The apparatus according to claim 12, wherein the pump comprises two pumping stages arranged in series.

14. The apparatus according to claim 13, wherein the pump comprises four pumping stages arranged in series.

15. The apparatus according to claim 12, wherein the stabilization structure comprises a safety valve arranged in parallel with the pump.
